(19) United States
(12) Patent Application Publication
(10) Pub. No.: US 2013/0107834 A1
(43) Pub. Date: May 2, 2013

(54) Method for Transmitting Data in a Communications Network

(71) Applicants: Akash Dutta, Haryana (IN); Vikas Arora, Haryana (IN)

(72) Inventors: Akash Dutta, Haryana (IN); Vikas Arora, Haryana (IN)

(73) Assignee: Nokia Siemens Networks, Espoo (FI)

(21) Appl. No.: 13/696,843

(22) PCT Filed: Apr. 8, 2010
(86) PCT No.: PCT/EP2010/054669

§ 371 Date: Nov. 8, 2012

(51) Int. Cl. H04W 4/10

(52) U.S. Cl. CPC H04W 4/10
USPC 370/329

(57) ABSTRACT

A method for transmitting data in a communications network including receiving an attribute of a radio access bearer, inspecting the attribute, identifying a PoC service in the radio access bearer if inspection of the attribute indicates presence of a PoC service in the radio access bearer, and setting a parameter of the radio access bearer in accordance with identification of a PoC service if a PoC service is identified in the radio access bearer

### FIELD OF THE INVENTION

The invention generally relates to a method for transmitting data in a communications system and, more particularly, to a push to talk over cellular (PoC) service in a radio access network (RAN).

### BACKGROUND OF THE INVENTION

The push to talk over cellular (PoC) service in a mobile communications system enables a user to engage in one-to-one or group calls much like the “walkie-talkie” experience. An advantage of the PoC service is that it allows a single person to reach an active talk group at a button press on a mobile without the need to make several calls in order to coordinate with the group. A PoC service uses SIP/VoIP for call management. The traffic characteristics of PoC are such that there is intermittent signalling/media activity followed by an indeterminate silence period. The key quality of experience (QoE) requirements for PoC are right-to-speak (RtS) delay, start-to-speak (StS) delay, voice-through delay and voice quality. The first two parameters measure how quickly the user can start to talk after pressing the push-to-talk button on the mobile terminal. Voice through delay measures how long the first voice packet takes to reach the other end and voice quality includes latency and jitter.

Internet high speed packet access (I-HSPA) is a PS only WCDMA based network solution with a flat architecture where RNC functionality is merged into the Node B (called an iNodeB), resulting in lower RTT and faster call setup. For any end-to-end service, the mapping of the service QoS to the packet data protocol (PDP) context QoS is performed by the application, then the mapping of PDP context to a radio access bearer (RAB)l by the core network (CN). The RAB defines the QoS level requirements for the radio access network (RAN) and the RAN controller entity (iNodeB) maps this in turn to the radio bearer. The radio bearer is further mapped to the transport channel and physical channel on a Iu interface so that the QoS requirements demanded in the RAB attributes are met with. The RAB QoS attributes are typically derived from the user QoS profile in HLR and the service specific QoS requirements (demanded by the mobile terminal).

Considering voice as the PoC media, the QoS requirements are very stringent in terms of RTT, jitter, etc., while the PoC signalling is bursty and does not require any real time QoS. During a silence period of an ongoing PoC service, the mobile terminal (UE) is preferably moved to a PCH state (Cell_PCH or URA_PCH state) and subsequent activity moves the UE back to a Cell_DCH state.

There are many alternative ways to map a PoC service to a RAN radio bearer. For example, the PoC signalling and media can be multiplexed to the same PDP context and radio bearer or may use a separate PDP context and radio bearer. The PoC media can be voice, video or text, although the predominant and immediate media is voice.

In the 3GPP Release 6 RAN, RAB Setup is a time consuming procedure and therefore the use of multiplexed PoC signalling and media on the same PDP context or radio bearer is often the preferred solution. When such multiplexing is used, the radio bearer should be able to provide voice quality, and state transition should be fast enough to meet StS/RtS requirements. Currently the 3G QoS architecture identifies four traffic classes; Conversational, Streaming, Interactive and Background and the recommended mapping for a PoC service is Interactive traffic class. However, this does not take into account voice quality of the PoC service.

In a typical PoC traffic profile there are indefinite periods of inactivity interleaved with spurts of voice, media conversations or calls. Therefore radio resources are released during periods of inactivity in order to save the radio capacity. The resource reservation from an idle state is a time consuming operation that can cause significant delays in PoC QoE. Additionally, when the same PDP context or radio bearer is used for multiplexed PoC signaling and media, the nature of the two traffic parts is very different, requiring a careful balance between performance and network resource utilisation. For example, the PoC signalling can be faster with a 384 kbps RB than with a 16 kbps RB but this would result in resource under utilisation as the signaling is intermittent and the bulk of traffic is voice media that requires around 16 kbps.

If the PoC service is mapped to Interactive traffic class, then there is the possibility of voice quality degradation in a loaded network as higher priority Streaming and Conversational services can take up most of the resources due to their higher priority. The problem of losing resources to higher priority traffic also occurs in RAN transport networks. For example, the higher DSCP is used for Streaming and Conversational traffic rather than the Interactive traffic class.

The invention addresses the above disadvantages and provides a method of handling data in a communications network, which improves PoC QoE and allows targets for PoC QoE to be achieved when PTT is used over WCDMA in a 3GPP release 6 RAN, without using an invasive method and without causing deterioration in performance and throughput.

### SUMMARY OF THE INVENTION

Accordingly, the invention provides a method of transmitting data in a communications network. The method comprises receiving an attribute of a radio access bearer. The attribute is then inspected. If inspection of the attribute indicates a presence of a PoC service in the radio access bearer, the PoC service is identified in the radio access bearer. Parameters of the radio access bearer are set in accordance with identification of a PoC service if the PoC service is identified in the radio access bearer.

An attribute or attributes of a radio access bearer are received from the core network (CN). The presence of a PoC service in the radio access bearer (RAB) is identified by inspecting the RAB attribute or attributes that are received from the CN. For example, if an attribute for a PoC service is set by the network operator, then this enables the network to identify from the received radio access bearer attribute that the service is not just a normal interactive service, but rather a PoC service run on an interactive traffic class. Once the network knows that a PoC service is present, it can handle the RAB as a PoC service. In this way, there is a special mapping of the PoC service to the RAB.

In this way, PoC quality of experience (QoE) targets are able to be achieved. For example, the method according to the invention provides the advantage of faster decisions for state transitions, especially in the case where there are multi RAB and/or multi-service situations in the network. In addition, blocking probability of the PoC service is advantageously reduced and better SPI/DSCP priority during PoC activity is achieved, which provides improved PoC voice quality. Furthermore, this is a non-invasive method. Since the method is non-invasive, it does not cause a reduction in performance or throughput.

Preferably, the data is transmitted over HSPA (high speed packet access) channels.

The step of setting the parameter may include raising a priority of the radio access bearer/radio bearer in network traffic.

The PoC service in the RAB may be given higher transport priority by using higher DSCP (DiffServe) value.

Additionally, the PoC service identified in the RAB can be given higher priority in an Admission decision. For example, an identified PoC RAB will be admitted faster and its admission is preferred over other RABs of the same traffic class. This provides the advantage of reducing the blocking probability of PoC RAB.

The PoC service detected in the RAB may also be given preference for allocation of HSPA/DCH channels during a state transition when there are also other RABs existing for a mobile station. For example, if a mobile station has three services (say email, web session and PoC), and it is currently inactive i.e. in a PCH state, then activity is indicated by the mobile station by sending a RRC: Cell Update message to the network (iNodeB). The iNodeB will then give the dedicated channel (DCH) resources (say HSPA channel) to the PoC RAB.

In one embodiment of the invention, the attribute includes a traffic class.

Additionally, the invention provides a carrier medium carrying computer readable code for controlling a computer to carry out the method of handling data in a communications network, with the method having the steps of receiving an attribute of a radio access bearer, inspecting the attribute, identifying a PoC service in the radio access bearer if inspection of the attribute indicates presence of said PoC service in the radio access bearer, and setting a parameter of the radio access bearer in accordance with identification of a PoC service if the PoC service is identified in the radio access bearer.

The carrier medium may include any form of storage medium or any form of transient medium such as a signal. The computer controlled by the code carried on the carrier medium may be provided in a network node, which can be an iNodeB or radio network controller (RNC). The RNC could be a legacy node (separate from the base station (NodeB)) or a collapsed node inside the NodeB (as in I-HSPA, for example).

The invention further provides a communications network having a network node and a control node. The control node is configured to receive an attribute of a radio access bearer, compare the attribute with a predetermined PoC attribute value and send the attribute to the network node. If the attribute of the radio access bearer matches the predetermined PoC attribute, then the network node is adapted to set a parameter of the radio access bearer in accordance with identification of a PoC service.

The network node can be an iNodeB, with a control node having RNC functionality provided in the iNodeB. The RNC functionality not only just identifies the PoC service in the RAB but also applies that identification for prioritization/admission control, etc. For example, the RNC receives the RAB attribute or parameter from the core network (CN) via operation and maintenance (O&M) actions and in turn sends the attribute(s) to the network node, as well as using the attribute(s) internally in admission/scheduling algorithms. The RNC can then compare the RAB attribute with a attribute values set by the network in accordance with a PoC service. For example, the RNC or an adapter (ADA) may contain a database storing predetermined attributes indicating a PoC service. These attributes or parameters of a PoC service may be configurable by the network operator. If the RAB attribute matches the predetermined possible PoC attributes then the control node controls the scheduler to set a parameter of the radio access bearer in accordance with PoC service detection.

The invention also provides a network entity, the network entity including attribute receiving means for receiving an attribute of a radio access bearer, inspection means for inspecting the attribute, identification means for identifying a PoC service in the radio access bearer if the inspection means indicates presence of the PoC service in the radio access bearer, wherein the network entity is adapted to set a parameter of the radio access bearer in accordance with identification of a PoC service if the identification means identifies said PoC service in the radio access bearer.

Preferably, the network entity is an iNodeB. This provides the advantage that a RNC capability is incorporated into a NodeB (base station transceiver (BTS)), therefore reducing the amount of hardware required in the network.

The invention will now be described, by way of example only, with reference to a specific embodiment, and to the accompanying drawing, in which:

### BRIEF DESCRIPTION OF THE DRAWINGS

FIG. 1 is a simplified schematic diagram of a communications network according to an embodiment of the invention.

### DETAILED DESCRIPTION OF AN EXEMPLARY EMBODIMENT

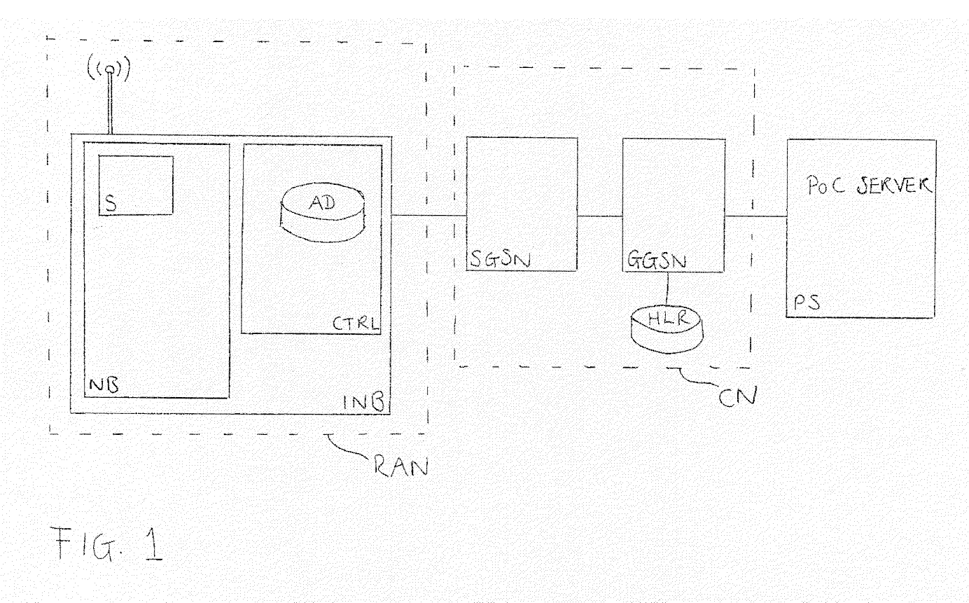

FIG. 1 schematically shows a communications network with a core network CN part and a radio access network RAN part. A mobile station UE is enabled for communication with the network. In the radio access network RAN, an iNodeB INB is located, which has a combined base station controller and base station functionality provided by a control node CTRL and a NodeB NB, respectively. The control node CTRL may be implemented by an adapter (ADA) or a radio network controller (RNC).

The control node CTRL includes a database AD storing predetermined RAB attributes indicating a PoC service. This expected set of attributes of a PoC service in the database AD is configured by the network operator and is shown in Table I.

The core network CN includes a serving GPRS support node SGSN and a gateway GPRS support node GGSN, which includes a home location register HLR containing information about subscribers to the network. A PoC server is attached to the GGSN, which is an application server outside the core network CN for handling PoC traffic. Communication from the PoC server PS to the iNodeB INB in the radio access network RAN takes place via the GGSN and the SGSN.

The mapping of a PoC Service to the RAB attributes stored in the database AD should be in synchronisation with the configuration of the network operator's core network CN and home location register HLR for a PoC service. After being configured by the operator, the RAB parameter set indicating a PoC service is delivered by the Operations and Maintenance (O&M) to the layer 3 (L3) application in the control node CTRL in the iNodeB INB.

In operation, a RANAP: RAB ASSIGNMENT REQUEST arrives at the iNodeB INB from the core network CN for establishment of a RAB towards the mobile station UE. In order to determine whether the RAB is meant for PoC traffic from the PoC server PS, at least one of the RAB attributes (shown in Table I) in the request is inspected by comparing it to the set of values stored in the database AD that the core network CN is expected to set for a PoC RAB. Either all of these attributes or just a subset of them may be compared with values stored in the database AD.

If inspection of the RAB attribute received from the core network CN determines that the attribute matches the set of the predetermined possible RAB attributes listed in Table I then a PoC service is identified in the RAB. The parameter(s) for the radio access network RAN are then set or adjusted in accordance with the identification of PoC traffic in the RAB. The control node CTRL controls the scheduler in the iNodeB to set a parameter of the radio access bearer in accordance with PoC service detection. This can be implemented, for example, by raising the priority of the PoC service in the RAB. This means that the HSDPA scheduler in the iNodeB would prioritise the traffic of a PoC RAB above other RABs of the same traffic class. For example, the PoC RAB could be given higher transport priority by using higher DSCP (DiffServe) value.

The PoC RAB is given higher priority in Admission decision. In other words, a detected PoC RAB will be admitted faster and its admission will be preferred over other RABs of same traffic class. This reduces the blocking probability of PoC RAB.

The PoC RAB is also given preference for allocation of HSPA/DCH channels during state transition when there are also other RABs existing for the mobile station UE. For example, if the mobile station UE has three services, say email, web session and PoC, and it is currently inactive; i.e., in a PCH state, if activity is then indicated by the mobile station UE by the mobile station UE sending a RRC: Cell Update message to the network (iNodeB), the iNodeB will preferentially allocate DCH resources (say HSPA channel) to the PoC RAB.

Although the invention has been described hereinabove with reference to a specific embodiment, it is not limited to this embodiment and no doubt further alternatives will occur to the skilled person that lie within the scope of the invention as claimed.

For example, the radio network controller or base station controller functionality could be separated from the NodeB or base station so that the RNC and NodeB form separate control node and network node.

Alternative methods may also be used for identification of a PoC service in the base station or iNodeB. For example, deep packet inspection in the iNodeB could also be used to detect establishment of PoC service (from SIP messages).

TABLE I

| | | | |
|---|---|---|---|
| >Traffic Class | M | ENUMERATED | Desc.: This IE indicates the |
| | | (conversational, streaming, | type of application for which |
| | | interactive, background, | the Radio Access Bearer service |
| | | . . .) | is optimised |
| >Traffic Handling Priority | C - | INTEGER | Desc.: This IE specifies the |
| | iftrafficInteractiv | {spare (0), highest (1), . . . , | relative importance for handling of all |
| | | lowest (14), no priority (15)} | SDUs belonging to the radio access |
| | | (0 . . . 15) | bearer compared to the SDUs of other |
| | | | bearers |
| | | | Usage: |
| | | | Values between 1 and 14 are ordered |
| | | | in decreasing order of priority, ‘1’ |
| | | | being the highest and ‘14’ the |
| | | | lowest. |
| | | | Value 0 shall be treated as a |
| | | | logical error if received. |
| >Delivery Order | M | ENUMERATED | Desc: This IE indicates whether the RAB |
| | | (delivery order requested, delivery | shall provide in-sequence SDU |
| | | order not requested) | delivery or not |
| | | | Usage: |
| | | | Delivery order requested: in |
| | | | sequence delivery shall be |
| | | | guaranteed by UTRAN on all RAB |
| | | | SDUs |
| | | | Delivery order not requested: |
| | | | in sequence delivery is not required from |
| | | | UTRAN |
| >SDU Error Ratio | C- | | Desc.: This IE indicates the |
| | ifErroneousSDU | | fraction of SDUs lost or detected |
| | | | as erroneous. |
| | | | This is a Reliability attribute |
| | | | Usage: |
| | | | The attribute is coded as follows: |
| | | | Mantissa * 10 − exponent |
| Mantissa | M | INTEGER | |
| | | (1 . . . 9) | |
| Exponent | M | INTEGER | |
| | | (1 . . . 6) | |
| >Residual Bit Error Ratio | M | | Desc.: This IE indicates the undetected |
| | | | bit error ratio for each subflow in the |
| | | | delivered SDU. |
| | | | This is a Reliability attribute. |
| | | | Usage: |
| | | | The attribute is coded as follows: |
| | | | Mantissa * 10 − exponent |
| >>Mantissa | M | INTEGER | |
| | | (1 . . . 9) | |
| >>Exponent | M | INTEGER | |
| | | (1 . . . 8) | |
| >Delivery Of Erroneous SDU | M | ENUMERATED | Desc.: This IE indicates whether SDUs |
| | | (yes, no, | with detected errors shall be delivered or |
| | | no-error-detection-consideration) | not. In case of unequal error protection, |
| | | | the attribute is set per subflow |
| | | | This is a Reliability attribute |
| | | | Usage: |
| | | | Yes: error detection applied, |
| | | | erroneous SDU delivered |
| | | | No. Error detection is applied, |
| | | | erroneous SDU discarded |
| | | | no-error-detection-consideration: |
| | | | SDUs delivered without considering |
| | | | error detection. |
| | | | If the RNC receives this IE |
| | | | set to ‘Yes’ and the User Plane |
| | | | Mode IE is set to ‘transparent |
| | | | mode’, it should consider it as |
| | | | ‘no-error-detection-consideration’. |

1. A method for transmitting data in a communications network, the method comprising receiving an attribute of a radio access bearer, inspecting said attribute, identifying a PoC service in the radio access bearer if inspection of said attribute indicates that said PoC service is present in the radio access bearer, and setting a parameter of the radio access bearer in accordance with identification of a PoC service if said PoC service is identified in the radio access bearer.

2. The method according to claim 1, wherein the step of inspecting comprises comparing the attribute of the radio access bearer with a predetermined attribute value set by the network for a PoC service in a radio access bearer.

3. The method according to claim 3, wherein the step of identifying comprises matching the attribute of the radio access bearer with the predetermined attribute value.

4. The method according to claim 1, wherein the step of setting the parameter includes raising a priority of the radio access bearer in network traffic.

5. The method according to claim 5, wherein the radio access bearer is given a higher MAC-hs/MAC-e scheduling priority.

6. The method according to claim 5, wherein the PoC service in the radio access bearer is given higher transport priority by using higher DSCP (DiffServe) value.

7. The method according to claim 5, wherein the PoC service in the radio access bearer is given higher priority in an Admission decision.

8. The method according to claim 5, wherein the PoC service in the radio access bearer is given preference for allocation of HSPA/DCH channels during a state transition when there are also other radio access bearers existing for a mobile station.

9. The method according to claim 1, wherein said attribute includes a traffic class.

10. A carrier medium carrying computer readable code for controlling a computer to carry out the method of claim 1.

11. A communications network comprising a network node, and a control node, wherein the control node is configured to receive an attribute of a radio access bearer, to compare the attribute with a predetermined PoC attribute value, and to send the attribute to the network node, and wherein the network node is operable to set a parameter of the radio access bearer in accordance with identification of a PoC service if the attribute of the radio access bearer matches the predetermined PoC attribute.

12. The communications network according to claim 9, wherein the network node is a base station.

13. The communications network according to claim 9, wherein the control node is a base station controller.

14. A network entity, comprising attribute receiving means for receiving an attribute of a radio access bearer, inspection means for inspecting the attribute, identification means for identifying a PoC service in the radio access bearer if the inspection means indicates presence of the PoC service in the radio access bearer, wherein the network entity comprises parameter setting means for a parameter of the radio access bearer in accordance with identification of a PoC service if the identification means identifies said PoC service in the radio access bearer.

15. The network entity according to claim 12, wherein the network entity is an iNodeB.
